(19) United States
(12) Patent Application Publication
(10) Pub. No.: US 2018/0055046 A1
(43) Pub. Date: Mar. 1, 2018

(54) Protective Surface Film for a Liquid

(71) Applicant: AQUATAIN TECHNOLOGIES PTY LTD, Victoria (AU)

(72) Inventor: Graham G. Strachan, Berwick (AU)

(21) Appl. No.: 15/805,732

(22) Filed: Nov. 7, 2017

Related U.S. Application Data
(63) Continuation-in-part of application No. 15/068,493, filed on Mar. 11, 2016.
Application No. 15/068,493 is a continuation of application No. 12/376,246, filed on Feb. 18, 2009, now abandoned.

(30) Foreign Application Priority Data
Aug. 4, 2006 (AU) 2006904227

(51) Int. Cl. A01N 25/30; B01J 19/16; A01N 25/10; A01N 65/00

(52) U.S. Cl. CPC A01N 25/30; B01J 19/16; A01N 65/00; A01N 25/10

(57) ABSTRACT

A composition and method for protecting the surface of an exposed body of water comprising 10 to 95 wt % silicone polymer; greater than zero to 15 wt % carrier material; and greater than zero to 20 wt % surfactant. The method includes the steps of adding the composition to the surface of the water and allowing the composition to form a liquid film across the surface of the water. The film is effective for reducing evaporation of water from the surface.

### FIELD OF THE INVENTION

The present invention relates to a protective surface film for a liquid and in particular stable protective surface films used to cover a large body of water to prevent evaporation.

### BACKGROUND TO THE INVENTION

The need to conserve scarce water supplies is a major environmental issue worldwide. As a result, an increasing level of attention is being directed to various water-saving measures. In particular, the loss of water through evaporation is one area of major concern. Measures to restrict evaporation have included the use of underground drip irrigation, the replacement of open irrigation channels with pipelines and restricting the application of water to times at which evaporation is kept to a minimum.

Several products have also been developed to reduce the evaporation from water bodies by covering the surface of the water, such as shade structures, plastic films and other floating membranes. However, the widespread adoption of such products has been inhibited by the substantial initial capital costs.

Chemical monolayers have also been proposed. These are powders which are dispersed on the water. They commonly incorporate an alcohol (such as cetyl or stearyl alcohol), which is known to help prevent evaporation by forming a barrier on the surface. An additive such as hydrated lime may also be blended with the alcohol to assist the alcohol to self-spread by creating charged particles.

The fundamental disadvantage with alcohol based monolayers is that the film typically degrades within a couple of days and therefore must be regularly re-applied to remain an effective barrier to water loss. In addition, trials have shown that alcohol layers are only partially successful in reducing evaporation with evaporation reductions of less than 30% reported.

Therefore there is a need for a cost effective composition for application to a liquid as a protective surface film which reduces the evaporation loss of the liquid for an extended period of time.

### SUMMARY OF THE INVENTION

The present invention is directed to compositions and methods for protecting a body of water.

In a first aspect, the invention provides a non-aqueous composition for the protection of a body of water comprising:

10 to 95 wt % silicone polymer;

greater than zero to 15 wt % carrier material, wherein the carrier material is or comprises a mineral oil and/or a vegetable oil; and

greater than zero to 20 wt % surfactant;

wherein a substantially continuous protective film is formed across a surface of the body of water when the composition is applied thereto and said protective film of said composition floats upon the body of water.

In a second aspect, the invention provides a method for protecting a surface of a body of water including the step of:

applying a film forming composition comprising:
(i) 10 to 95 wt % silicone polymer;
(ii) greater than zero to 15 wt % carrier material, wherein the carrier material is or comprises a mineral oil and/or a vegetable oil; and
(iii) greater than zero to 20 wt % surfactant;

to the surface of the body of water;

wherein the film forming composition forms a substantially continuous protective film across the surface of the body of water and floats thereon.

Suitably, the polymer of the aforementioned aspects is a polyorganosiloxane. Preferably, the polymer is a polymer of dimethylsiloxane.

In one embodiment, the polymer of the first and second aspects is present in an amount of 70 to 95 wt %.

Referring to the first and second aspects, the surfactant is suitably present in an amount of 0.5 to 20 wt %. Preferably, the surfactant is present in an amount of 0.5 to 10 wt %.

The mineral oil and/or the vegetable oil of the aforementioned aspects is suitably present in an amount of 5 to 15 wt %. Preferably, the mineral oil and/or the vegetable is present in an amount of 5 to 10 wt %.

With respect to the first and second aspects, the composition is suitably applied to the surface of the body of water at a rate of 0.3 to 90 gm/m2.

Suitably, the composition of the above aspects is a liquid at 25° C. (i.e., ambient temperature). Preferably, the composition has a viscosity of between 50 to 2000 centistokes at 25° C.

The composition of the above aspects suitably further comprises mixing of the surfactant and the carrier material before mixing with the silicone polymer.

In one embodiment of the first and second aspects, the composition has a surface tension of about 21 dynes/cm.

In one embodiment of the above aspects, the composition protects the body of water for a period of about 2 to about 4 weeks.

The composition of the aforementioned aspects suitably reduces evaporation of water from the body of water by about 30% to about 90%.

As used herein, except where the context requires otherwise, the term “comprise” and variations of the term, such as “comprising”, “comprises” and “comprised”, are not intended to exclude further elements, components, integers or steps but may include one or more unstated further elements, components, integers or steps.

It will be appreciated that the indefinite articles “a” and “an” are not to be read as singular indefinite articles or as otherwise excluding more than one or more than a single subject to which the indefinite article refers. For example, “a” surfactant includes one surfactant, one or more surfactants and a plurality of surfactants.

### DETAILED DESCRIPTION OF THE INVENTION

The present invention is at least partly predicated on the surprising discovery that silicon based polymers (including silicone base polymers) have the potential to be employed as a large scale liquid surface protector, such as unenclosed water storage facilities (eg. reservoirs or dams), when combined with a carrier material comprising a mineral and/or vegetable oil and a surfactant. Such a combination appears to overcome the inability of silicones to spread across a water surface: by themselves, silicones will form a lens on the surface of a body of water without spreading.

The composition preferably has sufficient spreadability to enable a flexible monolayer to be formed over a large water body. The monolayer preferably should remain flexible for an extended period of time and the monolayer should reduce evaporation. Ideally, the mono layer can also be used to control mosquitoes or odours. Additionally, the composition described herein should preferably be inert, resistant to UV radiation and oxidation, and/or have no deleterious impacts on the environment.

Accordingly, in one aspect of the invention, there is provided a non-aqueous composition for the protection of a body of water comprising:

10 to 95 wt % silicone polymer;

greater than zero to 15 wt % carrier material, wherein the carrier material is or comprises a mineral oil and/or a vegetable oil; and

greater than zero to 20 wt % surfactant;

wherein a substantially continuous protective film is formed across a surface of the body of water when the composition is applied thereto and said protective film of said composition floats upon the body of water.

In a related aspect, the invention provides a method for protecting a surface of a body of water including the step of:

applying a film forming composition comprising:
(i) 10 to 95 wt % silicone polymer;
(ii) greater than zero to 15 wt % carrier material, wherein the carrier material is or comprises a mineral oil and/or a vegetable oil; and
(iii) greater than zero to 20 wt % surfactant;

to the surface of the body of water,

wherein the film forming composition forms a substantially continuous protective film across the surface of the body of water and floats thereon.

The statements which follow apply equally to the two aforementioned aspects of the invention.

As used herein, the term “substantially continuous” refers to the protective film formed by the composition of the invention over the body of water being largely unbroken or uninterrupted over the surface area thereof. By way of example, the protective film may be considered “substantially continuous” if it is unbroken or uninterrupted over at least 90% (e.g., at least 90%, 91%, 92%, 93%, 94%, 95%, 96%, 97%, 98%, 99%, 100% and any range therein) of the surface area of the body of water to which the composition of the invention has been applied or added.

It would be appreciated that silicone polymers, such as polysiloxanes, are inorganic-organic polymers with the chemical formula [R₂SiO]n, where R=organic groups such as methyl, ethyl, and phenyl. These materials generally include an inorganic silicon-oxygen backbone ( . . . —Si—O—Si—O—Si—O— . . . ) with organic side groups attached to the silicon atoms, which are four-coordinate. In some cases organic side groups can be used to link two or more of these —Si—O— backbones together. By varying the —Si—O— chain lengths, side groups, and crosslinking, silicones can be synthesized with a wide variety of properties and compositions. They can vary in consistency from liquid to gel to rubber to hard plastic. The most common type is linear polydimethylsiloxane or PDMS. These polymers are known to be hydrophobic (water repellent) and possess a very silky feel which has led to their use in personal care products such as cosmetics, deodorants and shaving gels.

It would be appreciated by the skilled artisan, that the silicone polymer of the present invention may be any known in the art. The silicone polymer for use in the present invention is preferably a polyorganosiloxane, such as PDMS. Depending on the number of repeat units in the polyorganosilicone chain and the degree of cross linking between the polymer chains, the physical state of a polymer at a given temperature can be changed. By progressively increasing the cross linking of the polyorganosilicone such as polydimethyl silicone, solid elastomers and resins can be formed. The silicon polymer for use in the present invention is preferably in a liquid form, with the product dispersing into a film upon contact with the liquid surface. The silicone polymer fluids are typically straight chain polymers of dimethylsiloxane.

For ease of application the composition described herein preferably has a viscosity less than 2000 centistokes and more preferably between 50 and 2000 centistokes at the atmospheric temperature of application which is considered ambient temperature (i.e., 25° C.). In particular embodiments, the composition has a vicosity of about 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1100, 1200, 1300, 1400, 1500, 1600, 1700, 1800, 1900, 2000 centistokes or any range therein.

With respect to the above, the skilled artisan would appreciate that it may be beneficial to have a low viscosity silicone to assist the pourability of the product but, on the other hand, a higher viscosity silicone generally demonstrates more durability when applied on the surface of a body of water.

The silicone polymer is preferably of a type similar to Dow Corning “200 Fluid”, and is preferably the majority component in the composition (i.e., greater than 50 wt %). In particular embodiments, the silicone polymer is or comprises a polysiloxane, such as dimethyl siloxane.

The silicone polymer of the present invention may be present in an amount of about 10 to about 95 wt %, or any range therein such as, but not limited to, about 20 to about 90 wt %, or about 50 to about 80 wt %. In particular embodiments of the present invention, the silicone polymer is present in the composition described herein in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95 wt % or any range therein. In one preferred embodiment, the silicone polymer is present in an amount of about 70 to about 95 wt %.

As silicones or silicone polymers by themselves do not spread across the surface of water, other compounds are may be added to the silicone polymer composition to aid in the uniform spreading of the polymer over the liquid surface. A higher cross linking in the polysiloxane typically leads to a thicker polymer surface film, which would be expected to provide a better heat and mass transfer barrier at the liquid/gas interface.

The applicant has found that the addition of a surface active agent or surfactant consisting of a bipolar molecule enables the silicone polymer to spread across water to some degree. It is preferable if the surfactant is added up to quantities which allow a miscible solution with the silicone polymer to be formed at ambient temperature (i.e., 25° C.).

Accordingly, the surfactant of the present invention may be present in an amount of about 0.1 to about 20 wt %, or any range therein such as, but not limited to, about 0.2 to about 20 wt %, or about 0.5 to about 5 wt %. In particular embodiments of the present invention, the surfactant is present in the composition described herein in an amount of about 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0 wt % or any range therein. In one preferred embodiment, the surfactant is present in an amount of about 0.5 to about 10 wt %.

Non-limiting examples of surfactants which are suitable for use in the invention are listed below in Table 1.

TABLE 1
EXAMPLES OF SURFACTANTS

| Active Component | Brand Name |
|---|---|
| Nonylphenol ethoxylate | Teric N9 |
| Octylphenol ethoxylate | Triton X-114 |
| Polyalkylene oxide derivative of a synthetic alcohol | Teric BL8 |
| Tetramethyl decynediol | Surfynol 104H |
| Phosphate ester of an alkyl ethoxylate | Teric 305 |
| Alkyl polysaccharide | Alkadet 15 |
| Alkyl polyglycoside | Terwet 3001 |
| Sodium di(2-ethylhexyl) sulphosuccinate | Silfax T2 |
| Telomer B monoether with polyethylene glcol | Zonyl FSO |
| | Fluorosurfactant |
| Mixture of polyalkylenglycols and polyalkoxyesters | Clerol FBA 5074 |
| Modified polyalcoxyester, non ionic. | Clerol FBA5059K |
| Combination of polyalkylene glycols | Foamstop SIN 365 |
| Combination of polyalkylene glycols and esters | Foamstop SIN 365 |
| Di-(ethoxyalkyl) ester of phosphoric acid | Generic |

The list of suitable surfactants is not intended to be exhaustive of surfactants suitable for use in the invention. Other surfactants may be used provided that they are miscible with the mineral or vegetable oil carrier and the resulting surfactant composition is miscible with the silicone polymer used, which is preferably PDMS.

It has been found that the addition of a carrier material, such as a mineral oil or a vegetable oil, may greatly enhance the spreading strength of the blend. In order to enhance the mixing of the silicone polymer and surfactant, it is preferable that the surfactant is mixed with the carrier material prior to mixing with the silicone polymer. The surfactant may be present in the final blend up to 20 wt % (e.g., about 1, 2, 3, 4, 5, 6, 7, 8, 9, 10, 11, 12, 13, 14, 15, 16, 17, 18, 19, 20 wt % or any range therein) but more typically 5-20 wt % and preferably about 10 wt %.

One of the benefits of silicones and particularly PDMS is that its viscosity does not vary greatly over the operating temperatures of the composition. This allows reasonably accurate dosing through an automated dosing unit to be set up.

As a refinement, cetyl or stearyl alcohol or cetyl and stearyl acid derivatives can be incorporated into the composition. These derivatives may be alkaline, alkaline earth and other metal salts or esters of stearic acid.

These products have been known for many years to reduce evaporation. By themselves, their main disadvantages are that they are difficult to apply (being waxy flakes), they have poor resilience against strong wind or wave action (and hence can build up on one side of a water body), and they degrade very quickly to the extent that they have to be re-applied almost daily. Despite their normally rapid degradation when used in isolation, the applicant has found that they seem to improve and assist the effectiveness and lifespan of the silicone polymer-based compositions to some extent. When melted into the blend at a level of say up to about 5 wt % (e.g., about 0.5%, 1.0%, 1.5%, 2.0%, 2.5%, 3.0%, 3.5%, 4.0%, 4.5%, 5.0% and any range therein), but preferably up to about 2 wt %, they also improve the stability of the composition. In this regard, they seemingly minimise the physical separation of the composition into its component agents. This is advantageous if the product is to be applied through a dosing unit, where it is preferably homogeneous.

The carrier material of the present invention may be present in an amount of about 0.1 to about 15 wt %, or any range therein such as, but not limited to, about 0.2 to about 12 wt %, or about 0.5 to about 10 wt % of the composition. In particular embodiments of the present invention, the carrier material is present in the composition described herein in an amount of about 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0 wt % or any range therein. Preferably, the carrier material is present in an amount of about 5 to about 10 wt %.

The carrier material is preferably hydrophobic and is preferably selected from the group consisting of a mineral oil, a vegetable oil or mixtures thereof. As well as acting as a carrier for the surfactant, the oil (mineral or vegetable) may also be separately mixed with the silicone to reduce the cost of the composition. The addition of the oil also enhances the spreadability of the silicone polymer on the water. The total mineral and/or vegetable oil content is preferably in the range of about 0.1 to about 15 wt %, more preferably about 5 to about 15 wt % and even more preferably about 5 to about 10 wt %. In this regard, percentages of mineral and/or vegetable oil in excess of 15% seemingly lead to separation of said oil from the silicone polymer of the composition, as demonstrated in the Example below.

Within the context of the invention, a vegetable oil is a product of vegetable origin obtained by extracting the oil from seeds or fruits. Vegetable oils are liquid at ambient temperature and includes oils of canola, sunflower, safflower mustard, cotton and peanut, Vegetable oils also include palm oil, linseed oil, tung oil and castor oil.

A mineral oil is a by-product of the distillation of petroleum to produce gasoline. It is available in light or heavy grades. To be useful in the invention the viscosity of the mineral oil should be within the preferred viscosity ranges specified above. Various products are described commercially as mineral oil which includes white oil and paraffin oil and the person skilled in the art is familiar with this term of art.

In one preferred aspect of this first embodiment, to assist in the delivery of the composition, the above composition may be combined with an inert particulate or filler material. The film forming composition may be absorbed onto the particulate material to form a stable bulk material for ease of handling and storage. Examples of suitable particulate material include calcium carbonate, talc, and fine coal particulates, fly ash, or cenospheres (a lightweight, inert, hollow sphere filled with inert air or gas, which may be derived from fly ash). This list is not exhaustive and other fillers may be added, with their selection based on cost, density, hydrophobicity, inertness to the film forming composition, their ability to coat and adhere to the composition and ability to release the composition on contact with water. The silicone based polymer film may be chemically modified to enhance adhesion of the film onto the filler material. In extreme environments, UV additives or other polymer stabilisers may also be added to the composition.

The filler material may also possess other desirable functional properties. For instance, the surface film may also act as an insect suppressant and in particularly a mosquito suppressant. The dual functionality of the protective surface film addressing both water conservation and public health needs. The suppressant may be in a liquid form or may be part of or bound to the filler material. For example, sulphur and sulphur containing material are known to repel mosquitoes.

In particular embodiments, the surfactant may be initially mixed with a carrier material, such as a mineral and/or vegetable oil prior to mixing with the silicone polymer. The mineral or vegetable oil which may be added with the surfactant as well as separately.

The liquid surface area of the body of water is preferably large, such as water storage facilities (eg. reservoirs or dams), but may also include, for example, swimming pools or ponds. The composition may be applied from the periphery of the body of water or aerially, eg. via an airplane, such as a crop duster.

It would be apparent that the continuous silicone polymer based protective film preferably inhibits or controls the rate of heat and/or mass transfer across a liquid or water/gas interface of the body of water to which the composition described herein has been applied, such that evaporation of the water or liquid is reduced. As described previously, the continuous silicone based polymer protective film may further contain active ingredients which protect the water or liquid/gas interface from, for example, insect infestations.

Suitably the composition provided herein effectively protects the body of water for a period of about 2 to about 4 weeks. In particular embodiments, the body of water is protected for a period of about 14, 15, 16, 17, 18, 19, 20, 21, 22, 23, 24, 25, 26, 27, 28 days or any range therein. In this regard, it would be appreciated that the body of water is preferably to be protected against evaporation and/or insect infestation, such as mosquitoes.

In particular embodiments, the composition reduces evaporation of water from the body of water by about 30% to about 95% or any range therein, such as, but not limited to, about 50% to about 95%, or about 70% to about 90%. In particular embodiments, the composition reduces evaporation of water from the body of water by about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, or any range therein. In one preferred embodiment, the composition reduces evaporation of water from the body of water by about 30% to about 90%.

Further, it will be appreciated that the protective surface film may be applied to a range of different liquid surfaces to inhibit or control mass and/or heat transfer from a liquid/gas interface thereon or form a physical and/or chemical barrier against the gaseous environment therein. For example, the silicone based polymer composition may be applied to an oxidizable liquid to prevent or reduce oxidation thereof.

With respect to the aforementioned aspects, the silicone polymer-based composition is to be applied at an application rate of about 0.3 to about 90 grams per square meter of surface area of the body of water to which it is to be applied, or any range therein such as, but not limited to, about 0.5 to about 50 grams per square meter, or about 5 to about 30 grams per square meter of surface area of the body of water. In particular embodiments, the silicone polymer-based composition is to be applied at an application rate of about 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90 grams per square meter of surface area of the body of water or any range therein. Preferably the silicone polymer-based composition is to be applied at an application rate of about 0.3 to about 30 grams per square meter, and even more preferably about 0.3 to about 10 grams per square meter, and most preferably about 0.3 to about 1.0 grams per square meter.

The relatively low application rates and high stability of the silicone based polymer compositions, compared to alcohol based films, enables a protective surface film to be applied in a cost effective manner. Further, as the composition is substantially inorganic, the price of the composition will remain relatively stable in comparison to petroleum based films. With respect to stability, the composition described herein once applied may effectively protect the body of water for a period of about 2 to 4 weeks.

In light of the foregoing, it will be apparent to the skilled artisan that the composition described herein may possess a number of desirable properties, at least some of which are unexpected, including:

a) it is easy to apply (in liquid form), either from the banks of the water storage, by boat or by aerial spraying;
b) it floats naturally without the need for added buoyancy (the specific gravity is less than 1.0);
c) it self-spreads on the surface—even against significant wave pressure, such that is experienced on exposed bodies of water;
d) it has a high mechanical strength and even if the film is broken, it readily reforms, thereby maintaining the integrity and functionality of the film;
e) it is resistant to high temperatures, oxidation and ultra violet breakdown;
f) it is transparent and has a high oxygen permeability and therefore has minimal impact upon sub-surface aquatic life.
g) it is classified as non-hazardous and can therefore be safely applied to drinking water bodies; and/or
h) it remains effective for at least several weeks.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

All computer programs, algorithms, patent and scientific literature referred to herein is incorporated herein by reference.

Any reference to publications cited in this specification is not an admission that the disclosures constitute common general knowledge in Australia.

In order that the invention may be more readily understood and put into practice, one or more preferred embodiments thereof will now be described, by way of example only.

### Examples

In developing the invention, the applicant set out to develop a film forming composition having one or more desirable features.

In order to evaluate the spreadability of the various compositions to be tested, the applicant developed the following simple test. A rectangular tank 500 mm×200 mm was part-filled with water, and fine ground pepper was sprinkled on to the surface. The pepper covered the surface uniformly. When a drop of each formulation was applied by pipette to one end of the tank, the time taken for the pepper film to be compressed to the other end was measured.

Initially, the applicant tested a number of mineral oils, vegetable oils and commercially available siloxanes to determine their suitability for use as a film forming layer. As shown in Table 2, the applicant found that, by themselves, silicone polymers, mineral oils and vegetable oils do not spread spontaneously across the water surface.

TABLE 2
SPREADABILITY OF OILS

| | | SELF- |
|---|---|---|
| PRODUCT GROUP | TYPICAL PRODUCT | SPREADING? |
| Vegetable oils | Olive oil, peanut oil, canola oil, | No |
| | sunflower oil, sesame oil, mustard | |
| | seed oil, palm oil, cottonseed oil | |
| Mineral oils | Various products described as | No |
| | mineral oil, white oil or paraffin oil | |
| Silicones | Various viscosities ranging from | No |
| (Dow Corning | 50 cts to 10,000 cts | |
| 200 Fluids) | | |

In order to improve the spreadability of the above compounds, the applicant trialled the use of surfactants initially blended with a silicone or mineral or vegetable oil. Such compounds are marketed under the class of compounds known as defoamers which are also marketed as antifoamers.

The surfactants were first tested to determine their suitability as a film forming layer and the results of tests are shown in Table 3.

The applicant performed a number of spreadability tests on 18 commercially available defoamers which were a blend of surfactant and a carrier material as described above. When these compounds were then blended with a mineral oil or a vegetable oil, a slow spread was observed with the conclusion that a surfactant/oil blend was not suitable for use as a film forming composition for water surfaces.

Samples of silicone polymer (PDMS) commercially available as “200 Fluid” by Dow Corning was tested with mineral oil and canola oil using the spreadability test regime outlined above with the time taken to move the pepper to one edge of the tank timed. Oils and silicones were tested in combination and also in conjunction with an oil/surfactant defoamer marketed as SIL D850 marketed by Mera Chemicals containing about 10 wt % surfactant in a mineral oil carrier. The surfactant is sodium di (2-ethyl hexyl) sulphosuccinate and the results are shown in Table 3.

TABLE 3
SPREADABILITY TESTS

| FORMULATION PERCENTAGES (w/w) | | | | | |
|---|---|---|---|---|---|
| Silicone | | Vegetable | | | TIME TO |
| 200 Fluid | Mineral | oil | Defoamer | | SPREAD* |
| (50 cSt) | oil | (Canola) | (Sil D850) | TOTAL | Seconds |
| 100 | | | | 100 | 500+ |
| 95 | | | 5 | 100 | 6 |
| 90 | | | 10 | 100 | 5 |
| 70 | | | 30 | 100 | 5 |
| 85 | 10 | | 5 | 100 | 2 |
| 85 | | 10 | 5 | 100 | 2 |
| | 100 | | | 100 | 500+ |
| | 95 | | 5 | 100 | 22 |
| 5 | 90 | | 5 | 100 | 9 |
| | | 100 | | 100 | 500+ |
| | | 95 | 5 | 100 | 25 |
| 5 | | 90 | 5 | 100 | 11 |
| | | | 100 | 100 | 200+ |

It can be seem from the table that a blend of 85% silicone, 10% oil and 5% defoamer produced a very dramatic spread—taking only 2 seconds to spread. In fact, even for film forming compositions as low as 5 wt % silicone polymer, an acceptable spreadability was achieved. At the other end of the scale, a blend of 95% silicone polymer and 5% surfactant oil blend was also very effective.

It is surmised that the different spreading strengths exhibited by different formulations are functions of (a) the surface tension of each component and (b) the concentration of each component in the formulation. Table 4 below shows the surface tensions of various common liquids, with those relevant to this invention being highlighted.

TABLE 4
SURFACE TENSION OF VARIOUS LIQUIDS

| | | Surface tension |
|---|---|---|
| | | @ 20° C. in |
| Name | CAS No. | dynes/cm |
| Mercury | 7439-97-6 | 425 |
| Water | 7732-18-5 | 73 |
| Glycerol | 56-81-5 | 64 |
| Ethylene glycol | 107-21-1 | 48 |
| Benzylbenzoate | 120-51-4 | 46 |
| Diethylene glycol (DEG) | 111-46-6 | 45 |
| Nitrobenzene | 98-95-3 | 44 |
| Polyethylene glycol | 25322-68-3 | 44 |
| o-Nitrotoluene | 88-72-2 | 42 |
| Benzylalcohol | 100-51-6 | 39 |
| Methyl naphthalene | 90-12-0 | 39 |
| Pyridine | 110-86-1 | 38 |
| Nitromethane | 75-52-5 | 37 |
| Bromobenzene | 108-86-1 | 37 |
| Cyclohexanol 25° C. | 108-93-0 | 34 |
| Dipropylene glycol | 25265-71-8 | 34 |
| Chloro benzene | 108-90-7 | 34 |
| 1,4-Dioxane | 123-91-1 | 33 |
| Carbon disulfide | 75-15-0 | 32 |
| o-Xylene | 95-47-6 | 30 |
| 1-nitro propane | 108-03-2 | 29 |
| Ethylbenzene | 100-41-4 | 29 |
| n-Propylbenzene | 103-65-1 | 29 |
| Benzene | 71-43-2 | 29 |
| Ethylene glycol monoethyl ether | 110-80-5 | 29 |
| 1-Decanol | 112-30-1 | 29 |
| Acetic acid | 64-19-7 | 28 |
| Toluene | 108-88-3 | 28 |
| Isopropylbenzene | 98-82-8 | 28 |
| Butyronitrile | 109-74-0 | 28 |
| 1-Octanol | 111-87-5 | 28 |
| Chloroform | 67-66-3 | 28 |
| Mineral oil | 8042-47-5 | 28 |
| Dichloromethane | 75-09-2 | 27 |
| Carbon tetrachloride | 56-23-5 | 27 |
| Acetone | 67-64-1 | 25 |
| Cyclohexane | 110-82-7 | 25 |
| Methyl ethyl ketone | 78-93-3 | 25 |
| Propanol 25° C. | 71-23-8 | 24 |
| 1-Chlorobutane | 109-69-3 | 23 |
| Isopropanol | 67-63-0 | 23 |
| Methanol | 67-56-1 | 23 |
| Ethanol | 64-17-5 | 22 |
| Isobutylchloride | 513-36-0 | 22 |
| n-Octane | 111-65-9 | 22 |
| Polydimethylsiloxane (silicone) | 63148-62-9 | 21 |
| n-Hexane | 110-54-3 | 18 |
| Perfluorooctane | 307-34-6 | 14 |
| Perfluoroheptane | 335-57-9 | 13 |

To assess the impact on surface tension of various combinations of silicone and mineral oil, several samples were prepared and the surface tension of each sample was measured using a standard tensiometer. The silicone and oil were not miscible in many cases, and therefore the tests were carried out immediately after blending ie prior to separation of the liquids in the container. The measurements were undertaken with a standard tensiometer.

TABLE 5
SURFACE TENSIONS OF SILICONE/OIL COMBINATIONS

| | Silicone 200 | | Measured Surface |
|---|---|---|---|
| Sample | Fluid (50 cts) | Mineral oil | Tension |
| No | % w/w | % w/w | (dynes/cm) |
| 1 | 100 | 0 | 21 |
| 2 | 90 | 10 | 21 |
| 3 | 80 | 20 | 21 |
| 4 | 70 | 30 | 22 |
| 5 | 60 | 40 | 23 |
| 6 | 50 | 50 | 23 |
| 7 | 40 | 40 | 23 |
| 8 | 30 | 70 | 24 |
| 9 | 20 | 80 | 25 |
| 10 | 10 | 90 | 25 |
| 11 | 0 | 100 | 28 |

The surface tension of silicone by itself was measured at 21 dynes/cm (sample 1), and the surface tension of oil by itself was measured at 28 dynes/cm (sample 11). These readings are consistent with published data.

For those samples in which the silicone accounted for 80% or more of the blend (samples 2 and 3), the surface tension was the same as the surface tension of silicone by itself. The surface tension gradually increased as the proportion of silicone decreased. However, even at 5% silicone concentration, the surface tension was significantly less than the surface tension of mineral oil by itself.

The examples in Table 3 and Table 5, when taken together, demonstrate that an apparently small difference in surface tension of the composition translates into a much greater difference in spreading strength. By way of another example, if a drop of another product with a surface tension of say 27 dynes/cm is applied to water on a plate, it may well spread to cover the surface; but if a drop of the silicone polymer-based composition described herein with a surface tension of about 21 dynes/cm is then applied to the water where the other film is in place, the silicone polymer-based composition has been shown to compress the film produced by the other product into a small blob.

Silicones with lower viscosities, when blended with the defoamer or the defoamer/oil mix, seem to spread more easily than those with higher viscosities. For example, a Dow Corning “200 fluid” polydimethylsiloxane (PDMS) with a viscosity of 50 centistokes (cSt) spreads more easily than one with a viscosity of 1000 cSt. Silicones with a cSt above about 10,000 are generally not feasible for large water bodies as they are typically slow to spread and/or difficult to blend.

The exception is for relatively small-scale water bodies where a viscous product may be beneficial to accommodate an appropriate dosing unit. For example, a small dosing unit can be set up to automatically dispense a small amount of the product into the water over say a 3 month period. In this situation, it is desirable to have a viscous product so that the dosing rate is very slow. Even with a relatively high viscosity, the product would normally be able to cover most swimming pools.

In addition to being easily spread, it is desirable that the film formed has effective evaporation control. In order to test evaporation control, square containers 600 mm×600 mm were part-filled with water, and 0.2 ml of each formulation was applied by pipette. The drop or decrease in the water level was measured over a 10 day period, and was compared with the drop in a control container. The results of various silicone/surfactant/oil blends are shown in Table 6.

TABLE 6
EVAPORATION REDUCTION EXAMPLES

| FORMULATION PERCENTAGES | | | | | |
|---|---|---|---|---|---|
| Silicone | | Vegetable | | | EVAPORATION |
| 200 Fluid | Mineral | oil | Defoamer | | REDUCTION** |
| (50 cts) | oil | (Canola) | (Sil D850) | TOTAL | % |
| 95 | | | 5 | 100 | 65 |
| 90 | | | 10 | 100 | 67 |
| 85 | 10 | | 5 | 100 | 67 |
| 70 | | | 30 | 100 | 71 |
| 5 | 90 | | 5 | 100 | 55 |
| 5 | | 90 | 5 | 100 | 52 |

It can be seen that the use of a film forming composition according to the invention provides an improvement (i.e., reduction) in the evaporation rate.

### Mosquito Control

The applicant has also observed that the film disrupts the mosquito lifecycle. Female mosquitoes normally lay their eggs on the surface of the water, and the eggs hatch into larvae a few days later. The silicone-based film can potentially impact on this cycle in three ways:
as silicones have a very low surface tension (less than one-third of the surface tension of water), the eggs have difficulty suspending on the surface
the low surface tension prevents mosquito larvae and pupae from attaching at the surface to breathe, causing them to drown
a repellent such as citronella oil or eucalyptus oil can be incorporated into the blend, thereby further discouraging the mosquitoes.
polyisobutylene (commonly called PIB or synthetic rubber) could also be added to the formulation to assist with mosquito control

### Odour Control

The silicone-based film may also be blended with other components to assist in odour reduction. For example, the applicant has found that the formulation is compatible with terpenes, which are commonly used to absorb or mask odours. In laboratory trials, we have observed a reduction in odour when terpenes are blended into the silicone-based film.

### Silicone/Oil Concentrations

After it was established that the presence of an oil in the silicone polymer-based composition enhanced its spreading ability, the challenge of making the product stable in a drum or other container was approached. In this regard, stability is essential if the product is to be sold in bulk quantities, such as 200 litre drums, which then are unable to be remixed on site. Accordingly, a concentration of oil in which the silicone remained dissolved was sought.

The skilled person would understand that the literature typically describes silicone as immiscible with virtually every natural or man-made product except some solvents, which couldn't be included in the present composition owing to health and environmental concerns. Nevertheless, we sourced a wide range of oils (mineral, synthetic, vegetable and animal) and performed our own trials.

Table 7 below summarises the lab trials undertaken to determine the appropriate type and quantity of oil for the present composition from a stability aspect. As can be observed from this data, no oils were miscible with the silicone at concentrations above 1 part oil: 5 parts silicone (ie above 17% concentration). It was found, however, that if we incorporated mineral oil at less than 15 wt % concentration, the product was stable—even despite the fact that the literature indicated that silicone and mineral oil are immiscible. Some vegetable oils were also miscible at a similar concentration. Importantly, compositions with such concentrations of oil retained a strong spreading pressure (data not shown).

TABLE 7
SUMMARY OF STABILITY TRIALS
WITH SILICONE AND OIL

| | | Oil:Silicone Ratio | | | |
|---|---|---|---|---|---|
| | | 1:4 | 1:5 | 1:8 | 1:12 |
| | | (20% | (17% | (11% | (8% |
| Description | Source | oil) | oil) | oil) | oil) |
| Hydrocarbon | | | | | |
| Based Oils | | | | | |
| Mineral Oil BP85 | Apar | X | X | M | M |
| Mineral oil BP150 | Apar | X | X | M | M |
| Mineral oil BP350 | Apar | X | X | M | M |
| White Oil | Redox Pty Ltd | X | X | M | M |
| Synthetic Oils | | | | | |
| Diala 300 | Shell | X | X | X | X |
| Mobil 1 | Mobil | | X | | |
| Vegetable Oils | | | | | |
| Canola Oil | Select | X | X | X | M |
| Canola Oil | Homebrand | X | X | X | M |
| Carotino Oil | Carotina | X | X | X | X |
| (canola and palm) | | | | | |
| Castor Oil B.P. | Chemmart | X | X | X | X |
| Castor Oil | Tri-Tech | X | X | X | X |
| Hydrogenated | | | | | |
| Coconut Oil | Pujas | X | X | X | X |
| Corn Oil | Giorgio Borrelli | X | X | X | X |
| Grapeseed Oil | Azalea | X | X | X | X |
| Linseed Oil | Recochem | X | X | X | X |
| Mustard Oil | Ashok Oil Mills | X | X | X | X |
| Neemseed Oil | Enviro Neem | X | X | X | X |
| Olive Oil | Borges | X | X | X | X |
| Peanut Oil | Crisco | X | X | X | X |
| Pine Oil | In Essence | X | X | X | X |
| Rice Bran Oil | Alfa One | X | X | X | X |
| Sesame oil | ProChef | X | X | X | X |
| Sesame Oil | Shree Hari | X | X | X | X |
| (Gingelly) | | | | | |
| Soyabean Oil | Kings Choice | X | X | X | X |
| Sunflower Oil | Crisco | X | X | X | M |
| Tea Tree Oil | In Essence | X | X | X | X |
| Animal Oils | | | | | |
| Fish Oil | Nature's Own | X | X | X | X |
| Lanolin Grease | Lanolin Gold | X | X | X | X |

M = Miscible
X = Not Miscible
NOTES
350 cSt silicone was used in all of the above trials
Further trials with mineral oil, canola oil and sunflower oil showed the same results when 100 cSt silicone was used
Further trials with mineral oil, between the 17% and 11% levels, showed that 15% oil was about the maximum level to retain miscibility.

It will be understood that the invention disclosed and defined in this specification extends to all alternative combinations of two or more of the individual features mentioned. All of these different combinations constitute various alternative aspects of the invention.

1. A non-aqueous composition for the protection of a body of water comprising:
10 to 95 wt % silicone polymer;
greater than zero to 15 wt % carrier material, wherein the carrier material is or comprises a mineral oil and/or a vegetable oil; and
greater than zero to 20 wt % surfactant;
wherein a substantially continuous protective film is formed across a surface of the body of water when the composition is applied thereto and said protective film of said composition floats upon the body of water.

2. The composition of claim 1, wherein the polymer is a polyorganosiloxane.

3. The composition of claim 2, wherein the polymer is a polymer of dimethylsiloxane.

4. The composition of claim 1, wherein the polymer is present in an amount of 70 to 95 wt %.

5. The composition of claim 1, wherein the surfactant is present in an amount of 0.5 to 20 wt %.

6. The composition of claim 1, wherein the surfactant is present in an amount of 0.5 to 10 wt %.

7. The composition of claim 1, wherein the mineral oil and/or the vegetable oil is present in an amount of 5 to 15 wt %.

8. The composition of claim 1, wherein the mineral oil and/or the vegetable is present in an amount of 5 to 10 wt %.

9. The composition of claim 1, wherein the composition is a liquid at 25° C.

10. The composition of claim 1, having a viscosity of between 50 to 2000 centistokes at 25° C.

11. The composition of claim 1, further comprising mixing of the surfactant and the carrier material before mixing with the silicone polymer.

12. The composition of claim 1, wherein the composition has a surface tension of about 21 dynes/cm.

13. The composition of claim 1, wherein the composition protects the body of water for a period of about 2 weeks to about 4 weeks.

14. The composition of claim 1, wherein the composition reduces evaporation of water from the body of water by about 30% to about 90%.

15. The composition of claim 1, wherein the composition is applied to the surface of the body of water at a rate of 0.3 to 90 gm/m2.

16. A method for protecting a surface of a body of water including the step of:
applying a film forming composition comprising:
(i) 10 to 95 wt % silicone polymer;
(ii) greater than zero to 15 wt % carrier material, wherein the carrier material is or comprises a mineral oil and/or a vegetable oil; and
(iii) greater than zero to 20 wt % surfactant;
to the surface of the body of water, wherein the film forming composition forms a substantially continuous protective film across the surface of the body of water and floats thereon.

17. The method of claim 16, wherein the polymer is a polyorganosiloxane.

18. The method of claim 17, wherein the polymer is a polymer of dimethylsiloxane.

19. The method of claim 16, wherein the polymer is present in an amount of 70 to 95 wt %.

20. The method of claim 16, wherein the surfactant is present in an amount of 0.5 to 20 wt %.

21. The method of claim 16, wherein the surfactant is present in an amount of 0.5 to 10 wt %.

22. The method of claim 16, wherein the mineral oil and/or the vegetable oil is present in an amount of 5 to 15 wt %.

23. The method of claim 16, wherein the mineral oil and/or the vegetable is present in an amount of 5 to 10 wt %.

24. The method of claim 16, wherein the composition is a liquid at 25° C.

25. The method of claim 16, having a viscosity of between 50 to 2000 centistokes at 25° C.

26. The method of claim 16, further comprising mixing of the surfactant and the carrier material before mixing with the silicone polymer.

27. The method of claim 16, wherein the composition has a surface tension of about 21 dynes/cm.

28. The method of claim 16, wherein the composition protects the body of water for a period of about 2 to about 4 weeks.

29. The method of claim 16, wherein the composition reduces evaporation of water from the body of water by about 30% to about 90%.

30. The method of claim 16, wherein the composition is applied to the surface of the body of water at a rate of 0.3 to 90 gm/m2.
